(19) United States
(12) Patent Application Publication
(10) Pub. No.: US 2005/0125210 A1
(43) Pub. Date: Jun. 9, 2005

(54) System and method for providing a canonical structural representation of chemical compounds

(76) Inventor: Robert S. Pearlman, Austin, TX (US)

Correspondence Address: SPRINKLE IP LAW GROUP, 1301 W. 25TH STREET, SUITE 408, AUSTIN, TX, 78705, US

(21) Appl. No.: 10/994,167

(22) Filed: Nov. 19, 2004

Related U.S. Application Data
(60) Provisional application No. 60/523,972, filed on Nov. 21, 2003.
(60) Provisional application No. 60/524,138, filed on Nov. 21, 2003.

(51) Int. Cl. G06G 7/48; G06G 7/58

(52) U.S. Cl. 703/11; 703/12

(57) ABSTRACT

Embodiments of the present invention provide a system and method for representing chemical compounds in a canonical manner that enables one to associate multiple structures, including proto-stereomers, with a compound. Embodiments of the present invention can receive an input representation of a structure of a compound, neutralize acidic and basic atoms in the structure, remove chiral specifications associated with invertible and proto-invertible centers of the structure, and identify various neutral protomers of the compound based on tautomeric transforms applied based upon heuristic rules or other means to assess the plausibility of protomers or based upon any other set of rules. The neutral protomers can be canonically ranked and one of the neutral protomers can be selected as a canonically unique protomer for the compound. By generating a representation of the canonically unique protomer, the compound itself can be represented and identified in a canonically unique manner.

### RELATED APPLICATIONS

This application claims benefit of U.S. Provisional Patent Application No. 60/523,972, entitled “System and Method for Structural Representations of Chemical Compounds,” by Robert S. Pearlman, filed Nov. 21, 2003 and U.S. Provisional Application No. 60/524,138, entitled “System and Method for Providing Canonically Unique Structural Representation of Chemical Compounds,” by Robert S. Pearlman, each of which is fully incorporated by reference herein. This application is related to U.S. patent application Ser. No. ______, entitled “System and Method for Identifying Structures for a Chemical Compound” by Robert S. Pearlman, filed Nov. 19, 2004, which is hereby fully incorporated by reference herein.

### FIELD OF THE INVENTION

Embodiments of the present invention are related to computer based representations of molecular structures. More particularly, embodiments of the present invention are related to systems and methods for providing a canonical representation for chemical compounds.

### BACKGROUND

In the real (Natural) world, each chemical compound can exist in multiple “protomeric states” (reflecting different “protonation states” and different “tautomeric states”). As a compound is transformed from one protomeric state to another, it can also exist in multiple “stereomeric states” (reflecting different atom-centered chiralities and different bond-centered chiralities). These various protomeric and stereomeric possibilities correspond to the various possible structures for a given chemical compound. In contrast, in the in silico world (i.e. in a computer), each chemical compound is currently represented as a single structure. More specifically, current chemical databases associate a given compound with a particular structure of that compound. As a result, if two (or more) structures of the same compound are registered (entered into) a chemical database, they are typically treated as two (or more) different compounds and assigned different registration IDs even though, in the real-world, they are two “snapshots” of the same compound.

The situation above can lead to a variety of problems. For example, a company might collect real-world data which it associates with one structure of a compound and then inadvertently duplicate the effort of collecting the very same real-world data which it unknowingly associates with a different structure of the very same compound, mistakenly thinking that it is a different compound. Similarly, a company interested in purchasing an additional compound for testing could inadvertently purchase a compound it already owns but which is associated with a different structure in its database. This situation is a frequent occurrence at large pharmaceutical and agrochemical companies. Indeed, reputable companies selling chemicals often have inadvertent duplicates in their catalogs and disreputable companies attempt to boost sales by purposefully including different structures of the same compound in their catalogs of available compounds.

Prior art software programs can compare structures in an effort to determine if they correspond to the same compound. These programs address the fact that chemical compounds can exist in multiple protomeric states. However (in addition to occasional failures due to incomplete enumeration of protomeric states), these programs have invariably failed to address the fact that transformation from one protomeric state to another often induces a change in stereomeric state which is just as important to address. Thus, they continue to regard different stereo-isomers of a given structure as corresponding to different compounds even though the stereo-centers which differ between the two structures are “proto-invertible.” This term (and all other “quoted terms”) will be defined below.

### SUMMARY OF THE INVENTION

Embodiments of the present invention provide a system and method for identifying structures of chemical compounds that eliminate, or at least substantially reduce, the shortcomings of prior art methods. More particularly, embodiments of the present invention include systems and methods that can canonically represent a compound having multiple structures.

The following terminology is defined for purposes of this application: “stereo centers” include chiral atoms and chiral bonds; “stereomers” refer to different stereochemical isomers; “proto-centers” refer to atoms that can undergo protonation/deprotonation (e.g., acidic/basic atoms) and atoms that can undergo tautomeric transforms (e.g., proton-donors or and proton-acceptors); “protomers” are different protonation states and/or tautomeric states of a given compound; “protomeric state” refers to both the protonation state and tautomeric state of a given protomer; “protomeric transform” refers to the transformation from protomeric stateᵢ to protomeric stateⱼ, where stateᵢ and stateⱼ are different protomeric states; “proto-stereomers” are different protomers of a given compound which differ only with respect to chiralities of invertible or proto-invertible (pseudo-chiral) centers; “proto-stereo-conformers” refer to different 3D conformations of the proto-stereomers of a given compound; “invertible centers” are sp³-hybridized atoms (typically, nitrogens) with one lone-pair of electrons and three different bonded atoms; “proto-invertible (pseudo-chiral) centers” are atoms or bonds which can switch from one chiral state (e.g., an atom which can switch from R to S or a bond which can switch from E to Z) as a result of a reversible tautomeric transformation. Furthermore, it should be understood that an acidic atom, when neutral, has a hydrogen attached and can undergo deprotonation (give off a hydrogen/proton) to become negative. A basic atom, when neutral, can undergo protonation (accept a hydrogen/proton) to become positive. A tautomeric proton-donor can donate a hydrogen/proton to an atom that acts as a tautomeric proton-accepter. Following the transfer of the proton (hydrogen atom), the former proton-donor becomes a proton-acceptor and the former proton-acceptor becomes a proton-donor. Additionally, the term “in silico” is used to refer operations or representations in a computer environment. For example, an in silico tautomeric transform refers to a virtual or computer based tautomeric transform that is performed on data representing a structure, as opposed to a tautomeric transform that occurs to the actual compound in a natural environment. “Structural information” includes any information describing a structure, such as information in connection tables or other representations of a compound structure.

Embodiments of the present invention perform the following steps: (1) read the input and extract the connection table (lists of atoms and bonds, etc.) therefrom, (2) canonically re-order the connection table, (3) ensure that all acidic atoms and basic atoms are converted to their neutral forms, (4) identify all invertible and proto-invertible chiral centers, (5) remove any chiral specifications which might have been associated with invertible and proto-invertible chiral centers in the user's input, (6) enumerate all possible neutral protomers by using all possible tautomeric transforms but not using any protonation/deprotonation transforms, and (7) canonically rank the protomers from Step 6 and identify the highest ranking protomer as the canonically unique representation of the compound corresponding to the input structure.

The present invention provides a mechanism by which researchers can associate a canonically unique identifier with a compound, rather than working with identifiers of the various interconvertible proto-stereomeric forms in which that compound might exist. Embodiments of the invention provide a mechanism by which researchers can associate real-world data for a given compound with a canonically unique identifier of that compound, rather than with one or more identifiers of the various interconvertible proto-stereomeric forms in which that compound might exist. Use of the invention will benefit companies and scientists engaged in organic chemistry-related research for purposes including but not limited to the discovery of new and improved pharmaceuticals, herbicides, insecticides, “cosmeceuticals,” flavorings, detergents, paints, etc. which will not only benefit the manufacturers of such products but will also benefit society as a whole.

One aspect of the invention is using information regarding proto-invertible chiral centers in the process of deriving a canonically unique representation of a compound. In one embodiment, the invention is implemented in software code or firmware or both that is executable on a computer system (e.g., by a microprocessor).

One embodiment of the present invention is a method for canonically representing a compound based on a representation of a structure (e.g., a connection table or other representation) that contains structural information for the structure. The structural information can be reordered in a canonical format and proto-centers (i.e., acidic/basic atoms and true proton-donor/proton-acceptor pairs) can be identified for the structure. The method can further comprise modifying the structural information to neutralize acidic/basis atoms. Additionally, the method can include identifying proto-invertible centers (i.e., proto-invertible chiral atoms and proto-invertible chiral bonds) and removing any stereochemical specifications in the structural information for the proto-invertible centers. Embodiments of the present invention can identify neutral protomers from the structural information that has been normalized to neutralize acidic/basic atoms and to remove stereochemical specifications of invertible and proto-invertible atoms and bonds, canonically rank the neutral protomers, and select one of the neutral protomers as the canonically unique neutral protomer for the compound. A representation of the canonically unique neutral protomer can then be used as the canonically unique representation for the compound.

Another embodiment of the present invention is a method for canonically representing a compound based on a representation of a structure (e.g., a connection table or other representation) that contains structural information for the structure, comprising identifying proto-centers of the structure, modifying the structural information to neutralize acidic/basic atoms, identifying invertible and proto-invertible centers for the structure, removing stereochemical specifications for the identified invertible and proto-invertible centers, identifying one or more neutral protomers from the structural information that has been normalized to neutralize acidic/basic atoms and to remove stereochemical specifications of invertible and proto-invertible atoms and bonds, selecting one of the neutral protomers as the canonically unique protomer for the compound, and creating a canonically unique representation of the compound based on the selected neutral protomer.

Yet another embodiment of the present invention is a computer program product comprising a set of computer instructions stored on a computer readable medium. The set of computer instructions comprises instructions executable to receive a representation of a structure of a compound that includes structural information for the structure, identify proto-centers of the structure, modify the structural information to neutralize acidic/basic atoms, identify invertible and proto-invertible centers for the structure, remove stereochemical specifications for the identified invertible and proto-invertible centers, identify one or more neutral protomers from the structural information that has been normalized to neutralize acidic/basic atoms and to remove stereochemical specifications of invertible and proto-invertible atoms and bonds, select one of the neutral protomers as the canonically unique protomer for the compound, and create a canonically unique representation of the compound based on the selected neutral protomer.

Another embodiment of the present invention includes computer program product comprising a set of computer instructions stored on a computer readable medium. The set of computer instructions includes instructions executable to receive a representation of a structure of a compound that contains structural information for the structure, canonically reorder the structural information, identify acidic/basic atoms for the structure, identify true proton-donor/proton-acceptors pairs for the structure, modify the structural information to neutralize any acidic/basic atoms identified for the structure, creating neutralized structural information, identify invertible and proto-invertible centers for the structure, remove stereochemical specifications for the identified proto-invertible centers, identify one or more neutral protomers from the structural information that has been normalized to neutralize acidic/basic atoms and to remove stereochemical specifications of invertible and proto-invertible atoms and bonds, canonically rank the neutral protomers and select one of the neutral protomers as the canonically unique protomer for the compound and create a canonically unique representation of the compound based on the selected neutral protomer.

Yet another embodiment of the present invention is a computer program product that includes a set of computer instructions stored on a computer readable medium, the computer instructions comprising instructions executable to receive a representation of a structure of a compound of interest that contains structural information for the compound of interest, generate a canonically unique representation of the compound of interest and compare the canonically unique representation of the compound of interest to a set of canonically unique representations of compounds to determine if the canonically unique representation of the compound of interest matches any of the canonically unique representation in the set of canonically unique representations of compounds.

Another embodiment of the present invention is a method for determining if a compound is represented in a database that comprises receiving a representation of a structure of a compound of interest that includes structural information for the compound of interest, generating a canonically unique representation of the compound of interest and comparing the canonically unique representation of the compound of interest to a set of canonically unique representations of compounds to determine if the canonically unique representation of the compound of interest matches any of the canonically unique representation in the set of canonically unique representations of compounds.

Embodiments of the present invention provide an advantage over prior art systems and methods by canonically representing multiple structures of a compound in a canonical manner.

By providing a canonical format to associate multiple structures with a compound, embodiments of the present invention provide another advantage by allowing an entity to compare structures disclosed in the literature, vendor catalogs or through other sources to compounds already existing in the entity's database. This can reduce purchasing duplicate compounds.

As yet another advantage, canonical representations of compounds according to embodiments of the present can allow researchers to associate data gathered using different structures of the same compound with that compound. Additionally, the use of a canonical representation can reduce duplicative testing done by researchers who believe they are using different compounds when, in fact, they are using the same compound represented by different structures.

Embodiments of the present invention also provide an advantage by reducing the amount of computing required to compare compounds.

Given that large companies typically purchase and collect data on many thousands of compounds per year, the ability to associate a canonically unique structure and identifier with any given compound is of importance. This invention provides a robust method for doing so by converting any structure of a compound into a canonically unique structure of the same compound. A representation of the canonically unique structure can be used as a canonically unique identifier of the compound.

In addition, this invention can address the problems associated with establishing intellectual property rights for chemical compounds. Based on an application referencing structure X₂, company-B might be granted a patent for compound-X even though company-A had already been issued a patent based on structure X, of the same compound-X. By providing a robust method for associating any structure with the canonically unique structure of the same compound, the embodiments described herein provide a solution to this important problem.

### BRIEF DESCRIPTION OF THE DRAWINGS:

A more complete understanding of the present invention and the advantages thereof may be acquired by referring to the following description, taken in conjunction with the accompanying drawings in which like reference numbers indicate like features and wherein:

FIG. 1 is a diagrammatic representation of the multiple protomers for a single compound;

FIG. 2 is a diagrammatic representation of one embodiment of a software system for representing a compound according to a canonically unique format;

FIG. 3 is a flow chart illustrating one embodiment of method for representing a compound in a canonically unique format;

FIG. 4 is a diagrammatic representation of a protomeric transform and how such a transform could affect prediction of ligand-receptor interaction;

FIG. 5 is a diagrammatic representation of a tautomeric transform and how such a transform could affect prediction of ligand-receptor interaction;

FIG. 6 illustrates one embodiment of the application of heuristics in selecting protomers for further processing, according to one embodiment of the present invention;

FIG. 7 is a diagrammatic representation illustrating invertible and proto-invertible chiral atoms;

FIG. 8 is a diagrammatic representation illustrating proto-invertible atoms and bonds;

FIG. 9 is a diagrammatic representation of one embodiment of a computer system; and

FIG. 10 is a flow chart illustrating one embodiment of a method for determining if a compound is already represented in a chemical database.

### DETAILED DESCRIPTION

Preferred embodiments of the invention are illustrated in the FIGURES, like numerals being used to refer to like and corresponding parts of the various drawings.

Embodiments of the present invention provide a system and method for representing chemical compounds in a canonical manner that canonically represents multiple structures, including proto-stereomers, of a compound. Embodiments of the present invention can receive an input representation (e.g., a connection table) of a structure of a compound from a user, a database a file or other source, neutralize acidic/basic atoms in the structure, remove chiral specifications associated with invertible and proto-invertible centers of the structure, and identify various neutral protomers of the compound based on tautomeric transforms. The neutral protomers can be canonically ranked and one of the neutral protomers can be selected as a canonically unique protomer for the compound. By generating a representation of the canonically unique protomer, the compound itself can be represented in a canonically unique manner.

According to one embodiment of the present invention, a computer program can read an input representation of a structure (e.g., a connection table) and extract structural information from the connection table (or other representation), canonically re-order the structural information, analyze the structural information to identify all proto-centers, modify the structural information to neutralize acidic/basic atoms, identify all invertible and proto-invertible centers from the structural information, remove any chiral specifications that are associated with proto-invertible centers found in the structural information, enumerate all possible neutral protomers by using tautomeric transforms, canonically rank the neutral protomers and identify the highest ranking protomer as the canonically unique representation of the compound.

As described above, the following terminology is defined for purposes of this application: “stereo centers” include chiral atoms and chiral bonds; “stereomers” refer to different stereochemical isomers; “proto-centers” refer to atoms that can undergo protonation/deprotonation (e.g., acidic/basic atoms) and atoms that can undergo tautomeric transforms (e.g., proton-donors or and proton-acceptors); “protomers” are different protonation states and/or tautomeric states of a given compound; “protomeric state” refers to both the protonation state and tautomeric state of a given protomer; “protomeric transform” refers to the transformation from protomeric state to protomeric states, where stateᵢ and stateⱼ are different protomeric states; “proto-stereomers” are different protomers of a given compound which differ only with respect to chiralities of invertible or proto-invertible (pseudo-chiral) centers; “proto-stereo-conformers” refer to different 3D conformations of the proto-stereomers of a given compound; “invertible centers” are sp³-hybridized atoms (typically, nitrogens) with one lone-pair of electrons and three different bonded atoms; “proto-invertible (pseudo-chiral) centers” are atoms or bonds which can switch from one chiral state (e.g., an atom which can switch from R to S or a bond which can switch from E to Z) as a result of a reversible tautomeric transformation. Furthermore, it should be understood that an acidic atom, when neutral, has a hydrogen attached and can undergo deprotonation (give off a hydrogen/proton) to become negative. A basic atom, when neutral, can undergo protonation (accept a hydrogen/proton) to become positive. A tautomeric proton-donor can donate a hydrogen/proton to an atom that acts as a tautomeric proton-accepter. Following the transfer of the proton (hydrogen atom), the former proton-donor becomes a proton-acceptor and the former proton-acceptor becomes a proton-donor Additionally, the term “in silico” is used to refer operations or representations in a computer environment. For example, an in silico tautomeric transform refers to a virtual or computer based tautomeric transform that is performed on data representing a structure, as opposed to a tautomeric transform that occurs to the actual compound in a natural environment. “Structural information” includes any information describing a structure, such as information in connection tables or other representations of a compound structure.

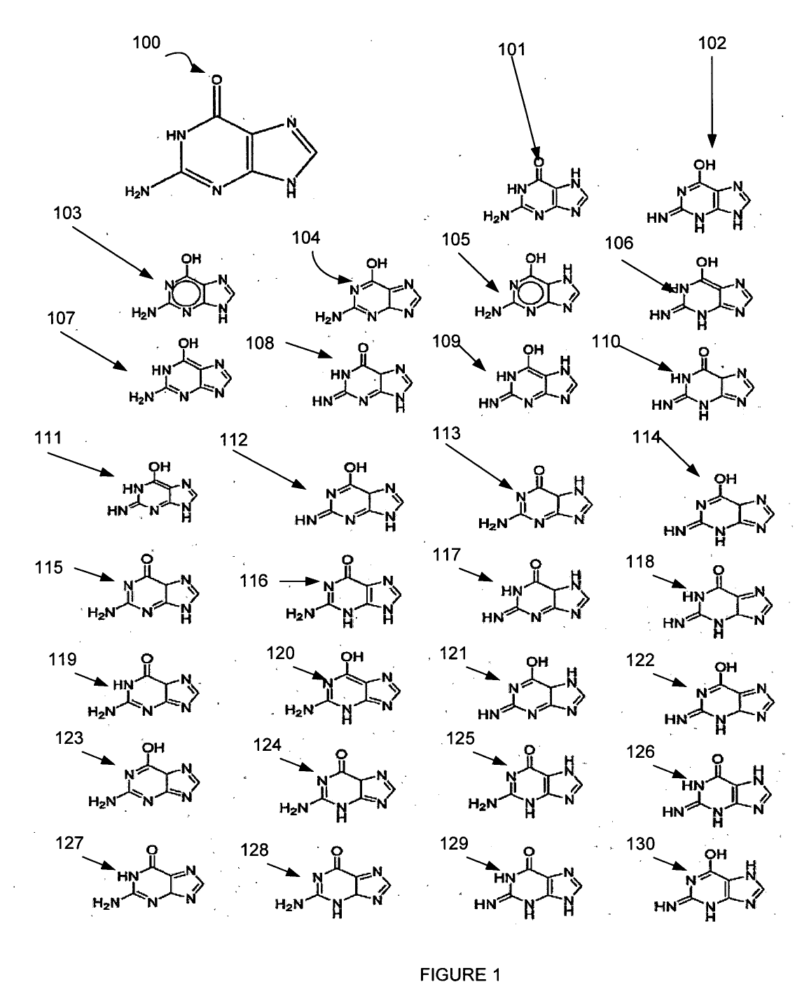

FIG. 1 is a diagrammatic representation of a set of structures 100-130 that correspond to the compound guanine. Typically, guanine is represented by structure 100 in chemical databases and the literature. In typical prior art systems, only one structure (e.g., structure 100) is associated with a compound. If a user wishes to determine if, say, structures 111 and 127 correspond to the same compound, some prior art systems would enumerate all the protomers of structure 111 and all the protomers of structure 127 and then compare lists to see if the two sets of protomers overlap. This type of analysis is very computationally intensive as it requires that two entire lists of protomers be compared. Embodiments of the present invention, on the other hand, provide a canonical representation for any structure. In this case, if the user wishes to determine if structure 127 corresponds to structure 111, embodiments of the present invention can convert both structure 111 and structure 127 into a canonical representations and assess correspondence by simply comparing the two canonical representations. Alternatively, each of the two canonical representations could be compared with the canonical representation of guanine stored in a database. The guanine compound of FIG. 1 will be used for explanatory purposes and it should be understood that the present invention can be used to canonically represent any number of compounds.

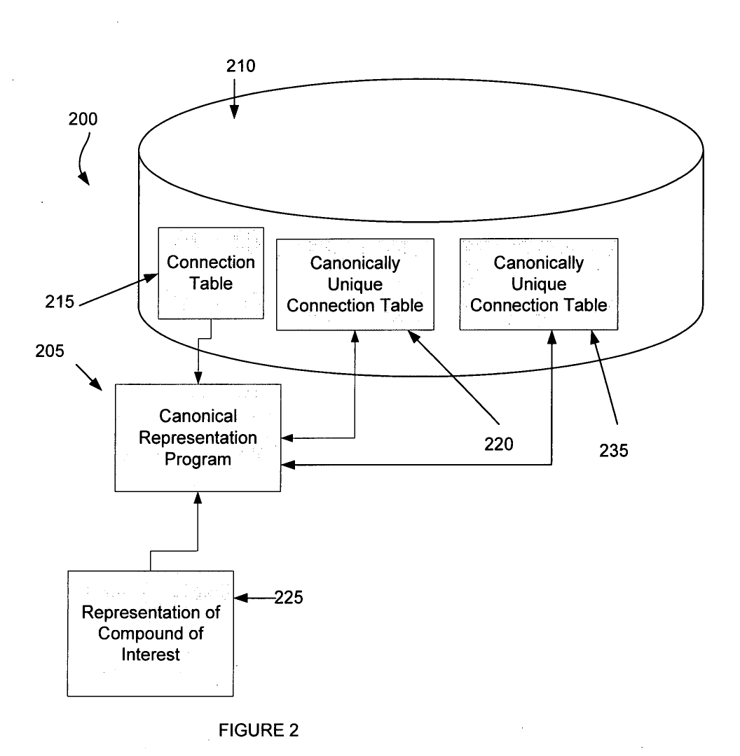

FIG. 2 is a diagrammatic representation of one embodiment of a computer program (e.g., software) system 200 for canonically representing a compound and comparing an input structure to the canonical representation. In the embodiment of system 200, computer program 205 can receive as an input a representation of a compound structure that includes structural information for the compound. The input can be loaded from a data storage system (e.g., from database 210, a file or other data storage mechanism), can be provided by a human user through a programmatic interface, received via a network (e.g., from another application or distributed storage) or otherwise provided to computer program 205. According to one embodiment of the present invention, the representation of the compound structure can take the form of an industry standard connection table 215. Connection table 215, as would be understood by those in the art, enumerates the atoms and bonds for a particular structure of a compound. According to other embodiments of the present invention, the compound structure can be represented in other manners, such as through connection tables according to proprietary or arbitrary formats, graphical representation in a graphical user interface or other input mechanism.

Computer program 205 can in silico reorder the structural information provided in the connection table in a canonical format for further processing. From the atoms and bonds provided, computer program 205 can identify the proto-centers (e.g., acidic/basic atoms and proton-donor/proton-acceptor pairs) and modify the structural information to ensure that all acidic and basic atoms in the representation of the structure are converted to their neutral forms. Computer program 205 can identify all invertible and proto-invertible centers (i.e., atoms and bonds that become chiral or achiral as the result of protomeric transforms) and remove any chiral specifications that may have been associated with the invertible and proto-invertible centers identified from the structural information of the input structure to normalize the structural information. Computer program 205 can then enumerate all the neutral protomers (or can enumerate all plausible neutral protomers based on plausibility rules or some subset of all possible protomers) of the compound from the normalized, neutralized structural information using tautomeric transforms but not protonation/deprotonation transforms. Computer program 205 can then canonically rank the protomers and identify the highest ranking protomer for representation as the canonically unique representation of the compound. The canonically unique representation 220 can be stored, for example, as a connection table in database 210 or according to another data storage mechanism.

Computer program 205 can further determine if a particular compound (referred to as a “compound of interest”) is already represented in database 210. Computer program 205 can receive a representation of a structure 225 (e.g., a connection table) containing structural information for a compound of interest, re-organize the atoms and bonds in a canonical format, identify proto-centers of the compound of interest, ensure that all acidic and basic atoms are converted to their neutral forms, identify invertible and proto-invertible centers for the compound of interest, remove any chiral specifications that may have been associated with the invertible and proto-invertible centers identified from the structural information for the compound of interest, enumerate all the neutral protomers (or all plausible protomers based on plausibility rules or some subset of all possible protomers) of the compound of interest using tautomeric transforms but not protonation/deprotonation transforms, then canonically rank the protomers. Computer program 205 can further identify the highest ranking neutral protomer for the compound of interest and enumerate a canonical structural representation 235 for the compound of interest. Computer program 205 can compare the canonical representation of the compound of interest to the canonically unique representations of structures in database 210. If the comparison is a match, the compound of interest is already represented in database 210, otherwise, the compound of interest is considered a new compound and the canonical representation 235 of the compound of interest can be added to database 210.

The embodiment provided in FIG. 2 is provided by way of example, but not limitation. As would be understood to those of ordinary skill in the art, embodiments of the present invention can be implemented as a set of computer executable instructions (software, firmware, or some combination thereof) stored on a tangible medium (RAM, ROM, EEPROM, Flash memory, optical storage, magnetic storage or other storage medium known in the art). The instructions can be accessible by the processor via a bus and memory controllers, over a network or in any other manner known in the art. The computer instructions can be implemented as a standalone program, multiple programs, modules of another program, callable functions or according to any suitable programming scheme and can be written in any suitable programming language such as C++ or other programming language.

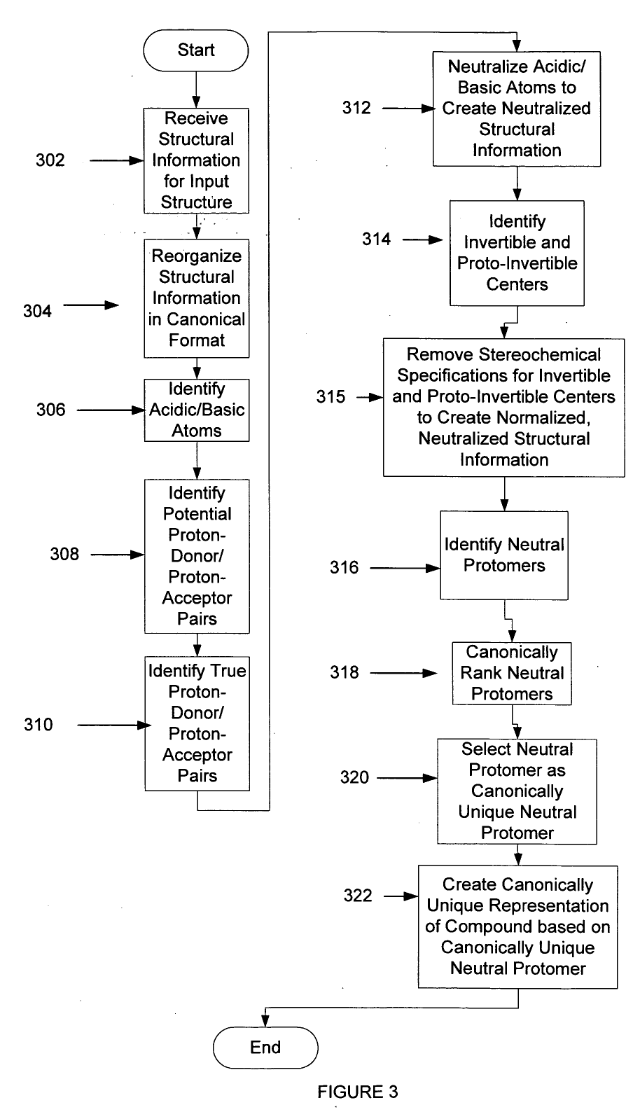

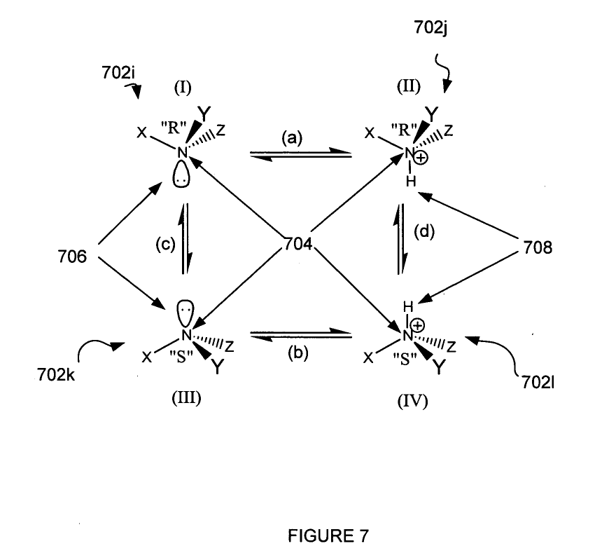

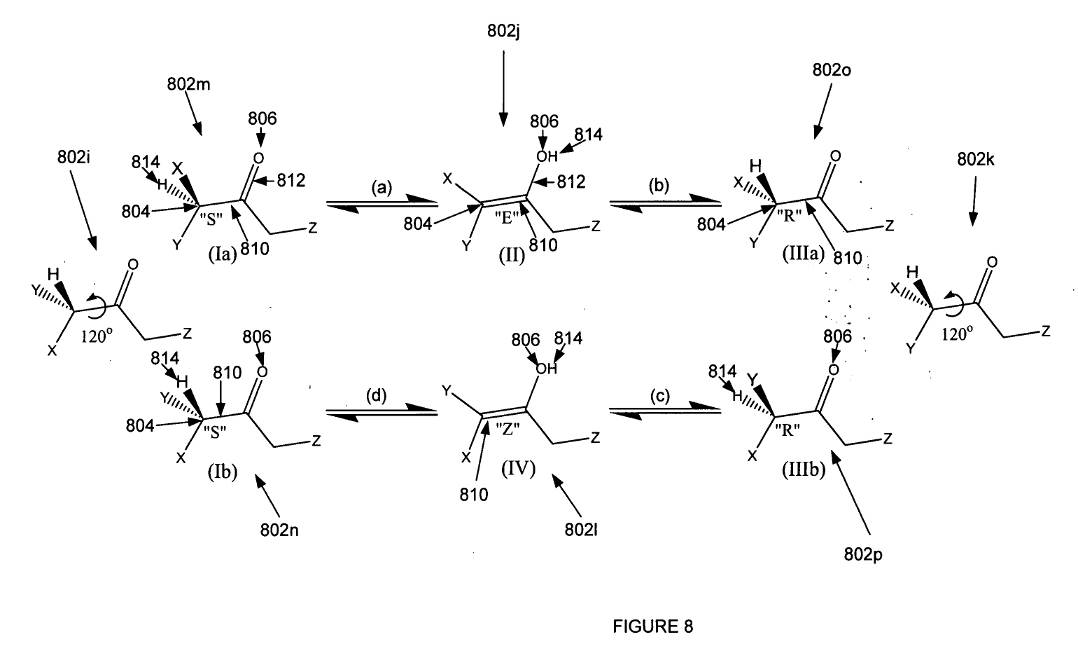

FIG. 3 is a flow chart illustrating one embodiment of a method for generating a canonically unique representation of a compound. The methodology of FIG. 3 can be implemented through execution of one or more sets of computer instructions (e.g., software programs, firmware, and/or hardware) stored on a computer readable medium. At step 302, structural information is extracted for an input structure of a compound. Typically, structural information for an input structure is provided in a connection table, though it should be understood that the initial compound structure can be input according to other mechanisms. Connection tables usually provide an atom number, from 1 to the highest number of atoms in the compound, the atomic number for each atom, the other atoms in the compound to which a particular atom is bonded, and the bond type of each bond. Connection tables can also include stereochemical specifications, such as specification of chirality for atoms and bonds. The connection table thus provides an in silico representation of a compound, including an ordered list of atoms and bonds, including the type of bond and atoms connected by the bonds for the input structure. From the connection table, the atoms, bonds and atom-centered and bond-centered chiralities of truly chiral atoms and bonds (as opposed to the chiralities of invertible and proto-invertible centers, described below in conjunction with FIGS. 7-8) can be determined.

The different protomers of a compound may contain a different number of protons, but all protomers contain the same heavy atoms bonded to each other in same fashion except for the bond types (e.g., single or double) of bonds contained in conjugated paths. Using the example of FIG. 1, all the protomers of guanine shown have oxygen, nitrogen and carbon atoms bonded to each other in the same fashion (e.g., the oxygen is bonded to the same carbon in each protomer and so on), but in the different protomers, the types of bonds between the atoms can be different (e.g., in structure 101, the oxygen is bonded to a carbon by a double bond while, in structure 102, the oxygen is bonded to the carbon by a single bond). Additionally, the number of hydrogen atoms can vary between protomers if acid/base protonation/deprotonation transforms are used.

Although the general content and format of connection tables is known in the art, there is no consistent standard as to the order in which the atoms are listed in a connection table. Since all protomers of a structure have the same heavy-atoms (i.e., non-hydrogen atoms) bonded to the same other heavy-atoms, the atoms and bonds for a compound, regardless of the order in which they are listed in the input connection table (or other representation of a compound's structure), can be rearranged in a canonical format (step 304). In other words, the structural information for the input structure can be canonically reorganized in a specified fashion, while still accurately describing the input structure.

In one embodiment, atoms are sorted into a canonically unique order by using the Morgan algorithm using atom (node) invariants defined as AtNo(i) +100-Degree(i), where AtNo(i) is the atomic number of atom-i and Degree(i) is the number of heavy atoms which are bonded to atom i. In this manner, the atoms are uniquely ranked and reordered in silico without reference to the protomeric state of the input structure. The ordering scheme is not affected by the number of hydrogen atoms attached to an atom or the types of bonds to the i atom. The Morgan algorithm is well known in the art. Other embodiments of the present invention can reorder the atoms according to other schemes known or developed in the art. The result of step 304 is a canonically ordered representation of the input structure. The canonically ordered representation can be, for example, a connection table or other representation of the input structure that can be stored in one or more memory locations for further manipulation by a computer program.

It should be noted that reordering of structural information in a canonical manner can occur at any point in the process of creating the canonically unique structural representation of the compound. For example, reordering of atoms and bonds in a canonical manner can occur after a particular protomer is selected as the canonically unique protomer for the compound (e.g., after step 320). However, performing this step earlier can make overall processing more efficient. More particularly, by canonically ordering the atoms and bonds of the initial set of structural information, the potential for enumerating duplicative protomers at later stages is reduced.

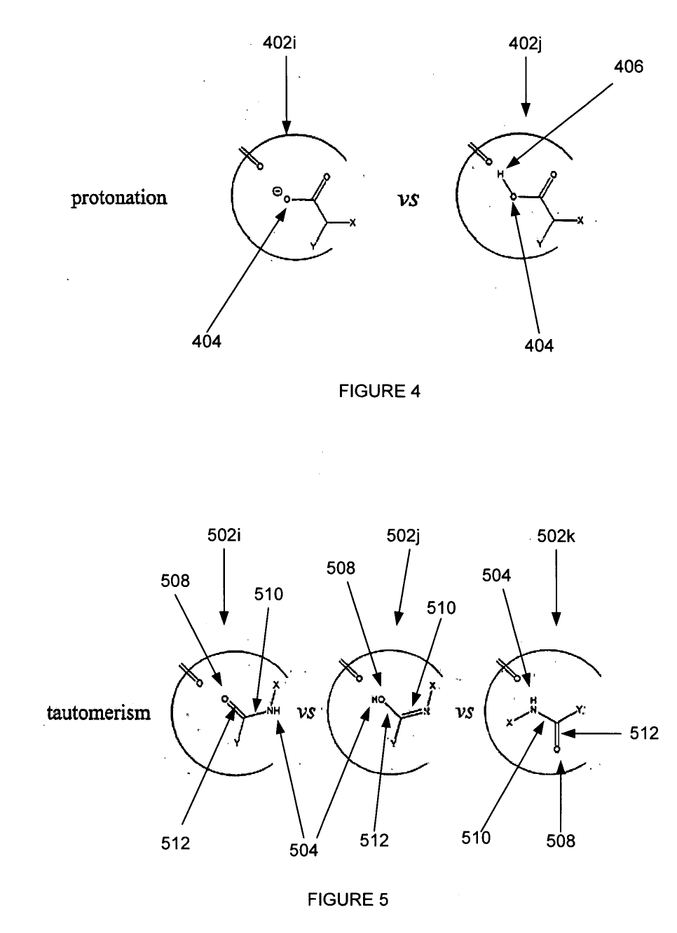

At steps 306, 308 and 310 proto-centers can be identified from the structural information of the input structure, whether the structural information is reordered in a canonical format or not. There are two types of proto-centers, atoms which undergo protonation/deprotonation and atoms which undergo tautomeric transforms. Deprotonation means the removal of a proton (hydrogen ion) from an atom which, prior to removal, was classified as an “acidic atom”. Following deprotonation, such atom is then classified as a “basic atom”. Protonation means the addition of a proton to an atom which, prior to the addition, was classified as a basic atom. Following protonation, the atom is classified as acidic. Protonation and deprotonation transforms increase and degrease the total number of protons in a molecular structure, respectively. FIG. 4 provides a diagrammatic representation of protonation. In step 306, atoms which undergo protonation/deprotonation can be identified by, for example, comparing the atoms in the connection table to a list of atoms that undergo protonation/deprotonation.

Atoms which can undergo tautomeric transforms can also be identified (step 308 and step 310). In contrast with protonation/deprotonation transforms, tautomeric transforms do not change the number of protons in the molecular structure. Rather, tautomeric transforms involve moving a proton from one atom, called a proton-donor, to another atom, called a proton-acceptor. Proton-donors include, but are not limited to, atoms previously described as acidic and proton-acceptors include, but are not limit to, atoms previously described as basic. At step 306, potential proton-donors and proton accepters in a given structure can be identified. This can be done, for example, by comparing the atoms enumerated in the connection table with a predefined list of possible proton-donor and proton-acceptors

When potential proton-donors and proton-acceptors have been identified based, for example, on a list of proton-donor and proton-acceptor possibilities, true proton-donors and proton-acceptors can be identified based on conjugated paths (step 310) found from the connection table (or other in silico representation of the input structure). For a potential proton-donor to be classified as a true proton-donor it must be connected to a potential proton-acceptor by one or more conjugated paths and for a potential proton-acceptor to be classified as a true proton-acceptor it must be connected to a potential proton-donor by one or more conjugate paths. It should be noted that the term “conjugated path” is well known in the art and is defined as a series of bonds that enable facile movement of a TT-electron from one end of the path to the other. Conjugated paths are made up of alternating signal and double bonds. As shown in FIG. 5, discussed below, tautomeric transform not only move a proton from a proton-donor to a proton-acceptor, but also change the bond-types of the bonds within the associated conjugated path (i.e., change single bonds to double bonds, and double bonds to single bonds). Once a tautomeric transformation is complete, the former proton-donor becomes a proton-acceptor. According to one embodiment of the present invention, the connection table can be analyzed to determine if conjugated paths exist between the potential proton-donors and potential proton-acceptors identified in step 308 to eliminate proton-donors and proton-acceptors which can not possibly participate in protomeric transforms. Additional analysis, as would be understood by those skilled in the art, can then be used to derive the true proton-acceptors and true proton-donors. The additional analysis can include, for example, the application of rules that define true proton-acceptors and true proton-donors.

At step 312, the structural information for the input structure can be modified to neutralize acidic and basic atoms. This can be done, for example, by performing in silico protonation/deprotonation transforms on the acidic and basic atoms. The hydrogen atoms and associated bonds can be added or removed from the representation of the input structure (e.g., the canonical structural representation) in accordance with the in silico protonation/deprotonation transforms resulting in neutralized structural information. It should be noted that charged atoms that are neither acidic nor basic retain their charge. In other words, neutralization, for the purposes of step 312, refers to neutralization of only acidic and basic atoms. Step 312 can result in neutralized structural information (e.g., organized in a canonical format).

Embodiments of the present invention, at step 314, can identify invertible and proto-invertible centers based of the input structure (e.g., through analysis of the initial representation of the input structure, the canonically ordered representation of the input structure or the neutralized canonically ordered representation of the input structure or other representation of the structural information for the input structure). Invertible atoms are described in greater detail below in conjunction with FIG. 7. The proto-invertible centers identified can include proto-invertible chiral atoms and proto-invertible chiral bonds. Identification of proto-invertible chiral atoms can be based on the application of one or more rules that define which atoms are proto-invertible given the structural information of each protomer. Generally, a chiral atom is an atom which has non-superimposable mirror image. For example, an atom with four non-equivalent atoms bonded to it in tetrahedral fashion is chiral. Inversion of the tetrahedron results in a structure which is the non-superimposable mirror image of the original. The two mirror images are typically designated as R and S. For some chiral atoms, protomeric transform followed by the reverse of that transform (or other tautomeric transform involving the same atom) can invert the chirality of such atoms. This is due to the fact that protons can be added to basic atoms or proton-acceptor atoms from either side, thereby creating either R or S chiralities. Such atoms are referred to as being proto-invertible centers. Invertible and proto-invertible chiral atoms are described in greater detail below in conjunction with FIGS. 7 and 8.

With respect to proto-invertible chiral bonds, a chiral bond is a double bond between two atoms of which neither is bonded to two equivalent atoms. Reversal of positions of the two atoms attached to one of the double-bonded atoms yields a different, non-superimposable stereomer. Such stereomers are traditionally designated Entgegen (“E”) or Zusammen (“Z”). As described earlier, conjugated paths consist of altering single and double bonds. Tautomeric transforms result in conversion of those double bonds to single bonds and vice versa. Unlike double bonds, single bonds are rotatable. After such a rotation is followed by another tautomeric transform which converts the single bond back to a double bond, the bond-centered chirality (i.e., E versus Z) is reversed. This is illustrated in FIG. 8, discussed below. Such bonds are referred to as proto-invertible chiral bonds.

At step 315, any stereochemical specifications associated with the invertible and proto-invertible centers are removed from the structural information. For example, if the initial connection table for an input structure assigns an indication of chirality (e.g., R or S) to an atom identified as a proto-invertible atom at step 314 or assigns an indication of chirality (e.g. E or Z) to a bond identified as a proto-invertible bond in step 314, the indication of chirality is removed for the atom or bond. However, according to one embodiment, stereochemical specifications (i.e., indications of chirality) for truly chiral bonds or truly chiral atoms are not removed. Removal of stereochemical specifications for invertible and proto-invertible centers will be reference herein as “normalization.” Normalization in this manner results in a normalized, neutralized, canonically ordered representation of an input structure with acidic and basic atoms neutralized and stereochemical specification for invertible and proto-invertible centers removed.

At step 316, a set of “neutral” protomers can be identified from the normalized, neutralized structural information that results from steps 312 and 315. The normalized, neutralized structural information can be contained in, for example a normalized, neutralized, canonically ordered representation of the input structure. The protomers are referred to as neutral, for purposes of the present invention, because the acidic and basic atoms have been neutralized before protomeric transforms occur, though other charged atoms may remain. Neutral protomers can be identified by performing in silico tautomeric transforms based on the normalized, neutralized structural information for the input structure. Tautomeric transforms are discussed in greater detail in conjunction with FIG. 5. The neutral protomers can be generated by, for example, performing all possible tautomeric transforms, a set plausible tautomeric transforms or an arbitrarily defined subset of all possible tautomeric transforms. If there were four proton-donor/proton-acceptor pairs, each connected by a single conjugated path, and each path independent of the other paths, there would be 2⁴ or 16 tautomeric possibilities (there would be sixteen neutral protomers). For a particular in silico tautomeric transform, the selection of one conjugated path for the tautomeric transform can limit selection of other conjugated paths that share bonds for that transform. For example, if in stateᵢ a structure has two conjugated paths “a” and “b” that share a common double bond, the selection of path “a” for a tautomeric transform means that path “b” cannot be simultaneously selected for a tautomeric transform. This is because the shared double bond of paths “a” and “b” will convert to a single bond after the tautomeric transform using path “a”, meaning that path “b” is no longer conjugated. A tautomeric transform can be independently performed in silico, selecting path conjugated path “b”.

Embodiments of the present invention can, thus, identify the protomers for a given input structure by performing in silico tautomeric transforms between true proton-donor/proton-acceptor pairs along conjugated paths identified from the structural information for the input structure. The in silico tautomeric transforms can be performed heuristically such that the in silico tautomeric transforms can be performed on an in silico structure generated from a previous in silico tautomeric transform of the input structure. There are a variety of methods known in the art to determine the various tautomeric possibilities for a structure. Tautomeric enumeration, for example, uses a topological approach that performs all the possible in silico tautomeric transforms available for an input structure. However, this can result in a great number of tautomeric possibilities, many which may not exist in nature. If all the possible tautomeric transforms are performed between apparent proton-donor/proton-acceptor pairs on: Nc1nc2nc(N)nc3nc(Nc4nc5nc(N)nc6nc(Nc7nc8nc(N)nc9nc(N)nc(n7)n98)n c(n4)n56)nc(n1)n23, there are approximately 55,251 tautomers (e.g., tautomeric possibilities). Empirical research has, however, shown that there may only be one tautomer of this compound that appears in the real world. Therefore, using tautomeric enumeration may lead to a great number of tautomers that are not plausible in nature.

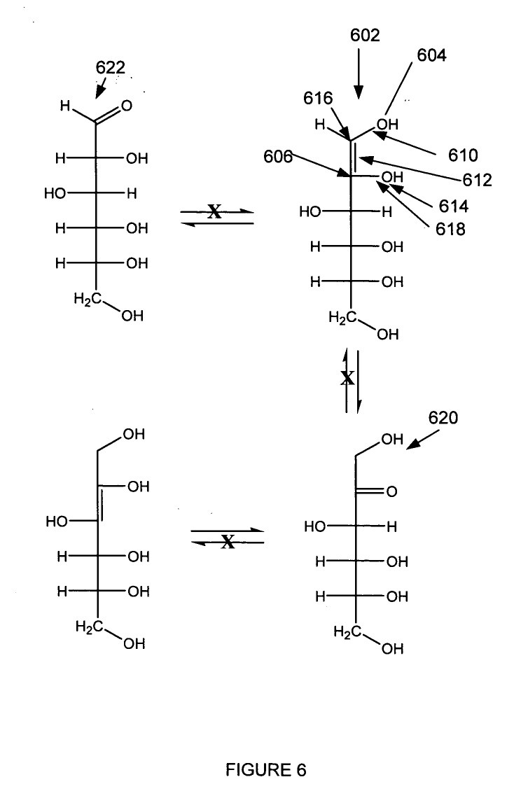

According to one embodiment of the present invention, rules can be applied to reduce the number of protomers selected for further processing. The rules can be applied such that plausible protomers are enumerated for further processing. Rules for generating an arbitrary set of plausible protomers will be referred to, for the sake of simplicity, as “plausibility rules”. Plausibility rules can be applied in a variety of manners including heuristically. Plausibility rules can be provided such that certain protomeric transforms are not applied in silico, or can be applied to the results of in silico transforms to eliminate particular protomers. For example, one plausibility rule may dictate that a particular in silico tautomeric transform should not be performed in the first place while another plausibility rule can be applied to determine if a protomer created by a particular in silico transform should be selected for further processing based on predefined criteria. As an example, in determining protomeric states for an input structure, embodiments of the present invention may, for example, apply enol→keto transforms but not perform keto→enol transforms. This rule models the fact that keto states are usually lower in energy than enol states, so it is less plausible for a keto→enol transform to occur in nature. Moreover, formation of enol can lead to scrambled chiralities in carbohydrates, peptides and other compounds. However, exceptions to this rule can exist. A keto→enol transform may be applied for activated methylenes with a second electron withdrawing group, 1,2-dione systems, or to transform cyclohexadiene-one to phenol. In the example of cyclohexadiene-one to phenol, applying a keto→enol transform models the fact that compounds in nature will generally take more aromatically stable state. Thus, for example, keto tautomers of phenols will not be identified for further processing, but keto tautomers of most hydroxy furans and pyrroles will be identified. The application of an example keto to/from enol transform rules are illustrated in greater detail in conjunction with FIG. 6.

Other rules can include, for example, that in silico tautomeric transforms that disrupt aromaticity will not be performed. Using the example above of Nc1nc2nc(N)nc3nc(Nc4nc5nc(N)nc6nc(Nc7nc8nc(N)nc9nc(N)nc(n7)n98)n c(n4)n56)nc(n1)n23, only one tautomer is identified for further processing if tautomeric transforms that disrupt aromaticity are not performed. For some compounds, however, tautomeric transforms that disrupt aromaticity may be performed because of other factors. For example, the keto form of some hydroxyl furans and pyyroles may be selected for further processing as the amide and ester resonance stabilizes the keto form of those hydroxy furans and pyyroles. As another example, a plausibility rule can dictate that protomers that fall outside a particular energy window (e.g., a user-specified energy window) are not selected for further processing. This is similar to the energy window concept used when considering conformers, but is based on the energy of a protomer rather than the energy of a conformation. Thus, plausible protomers can be selected based on molecular energies. The plausibility rules provided above are provided by way of example, but not limitation. Other plausibility rules can be implemented as rules are developed to determine which protomers are more or less plausible in nature.

The set of neutral protomers identified for further processing can include all possible neutral protomers based on an input structure, a set of plausible neutral protomers as defined by plausibility rules or other mechanism, or an arbitrarily selected set of protomers based on user specifications (e.g., only up to the first hundred protomers will be selected for further processing), processing limitations or other criteria. The neutral protomers selected for further processing can be enumerated, for example, through enumerating connection tables or other in silico representation for providing structural information of each selected protomer.

At step 318, the neutral protomers can be ordered. Ordering of the neutral protomers can occur in a manner such that ranking always occurs in the same way. According to one embodiment, the neutral protomers are ranked by first choosing those with the largest number of atoms in rings or ring systems that satisfy the 4n+2 Rule (i.e., the Huckel Rule). If two protomers are tied, the tie can be broken by choosing, for example, the neutral protomer with the most hydrogen atoms bonded to atom-1. If two or more remain tied, the tie can be broken by choosing the neutral protomer with the most hydrogen atoms bonded to atom-2 and so on. This process can continue until a particular protomer is identified as the highest ranking protomer. One of the neutral protomers, such as the highest ranking neutral protomer, can be selected as the canonically unique protomer to represent the compound (step 320) and a representation of the canonically unique protomer can be generated to create a canonically unique representation of the compound (step 322). Thus a canonically unique representation of a compound will be a representation of the selected (e.g., highest ranking) neutral protomer. It should be noted that the ranking scheme described above is provided by way of example and any neutral protomer can be selected as the canonically unique protomer for the compound so long as selection of the neutral protomer occurs in a canonical manner.

Embodiments of the present invention can thus provide a canonically unique representation of a compound for a given input structure. Embodiment of the present invention can, in silico, reorder structural information for an input structure in a canonical format, identify proto-centers from the structural information, neutralize acidic and/or basic atoms, identify invertible and proto-invertible centers (atoms and bonds), remove any stereochemical specifications associated with the invertible and proto-invertible centers in the structural information, and identify neutral protomers for the compound from the normalized, neutralized structural information. One of the neutral protomers can be selected as the canonically unique protomer for the compound. The compound can be represented in a canonically unique manner through a representation of the selected neutral protomer. The methodology of FIG. 3 can be repeated as needed or desired. Additionally, it should be noted that the order of steps illustrated in FIG. 3 is provided by way of example and the steps can be performed in other orders.

FIG. 4 is a diagrammatic representation of protonation in the context of ligand-receptor interaction. In FIG. 4, a compound in stateᵢ (identified at 402ᵢ) undergoes a protomeric transform (e.g., protonation) to stateⱼ (identified at 402ⱼ). The compound at 402ᵢ includes an oxygen atom 404 that is negative. During protonation, a hydrogen ion 406 bonds with oxygen 404 to form an acidic compound at 402ⱼ. Both 402ᵢ and 402ⱼ represent different protomers of the same compound. 402ⱼ can interact (dock) favorably with the receptor whereas 402ᵢ can not.

FIG. 5 is a diagrammatic representation of tautomerism. In the example of FIG. 5, the compound has at least three tautomeric and docking possibilities, represented at 502ᵢ, 502ⱼ and 502ₖ. 502ⱼ and 502k represent favorable docking possibilities whereas 502ᵢ is an unfavorable possibility. In state 502ᵢ, a hydrogen ion 504 is bonded to a nitrogen atom 506. Nitrogen atom 506 is separated from oxygen 508 via a conjugated path made up of single bond 510 between nitrogen atom 506 and a carbon atom (shown as the junction of bonds 510 and 512) and a double bond 512 between the carbon atom and oxygen 508. In a tautomeric transform, hydrogen ion 504 can move along the conjugated path to bond with oxygen atom 508. In this case, nitrogen atom 506 acts as a proton-donor and oxygen atom 508 acts as a proton-acceptor. Note that at 502ⱼ, bond 510 is now a double bond and bond 512 is now a single bond. Hydrogen ion 504 can move back to oxygen atom 508 along the conjugated path formed by bond 510 and 512 to result in 502ₖ.

FIG. 6 illustrates one embodiment of the application of heuristics (plausibility rules) in selecting protomers for further processing. Assume, for example, that structure 602 is provided as an input structure (e.g., the structural information for structure 602 is provided by way of a connection table). Embodiments of the present invention can identify the various true proton-donor/proton-acceptor pairs, as discussed above based on atoms known to be proton-donors/proton-acceptors and conjugated paths. For example, oxygen atom 604 and carbon atom 606 (carbon atoms are generally represented in the art as a junction of bonds) can be identified as a true proton-donor/proton-acceptor pair based on the fact that oxygen atom 604 can shed hydrogen ion 608 and is separated from carbon atom 606 by a single bond 610 and a double bond 612. Similarly, oxygen atom 614 and carbon 616 are a true-proton-donor/proton-acceptor pair separated by single bond 618 and double bond 612. Embodiments of the present invention can perform in silico enol~keto transforms to transform structure 602 to identify structure 620 and structure 622. These structures could then be enumerated by, for example, connection tables that show the changes in hydrogen ions and bonds. If, on the other hand, structure 622 is provided as the input structure (i.e., if structural information for structure 622 is provided), embodiments of the present invention would not, according to a plausibility rule, perform an in silico keto→enol transform to identify structure 602.

A plausibility rule such as this can be in place to model the fact that the keto form is usually lower in energy than the enol form and, therefore, it is less likely that the compound will take the enol form in nature. However, exceptions to such a rule can also be implemented. Examples of other rules include rules based on aromaticity (e.g., tautomeric forms that disrupt aromatic stability will not be selected for further processing) or energy windows (e.g., only protomers within a particular energy window will be selected for further processing). The examples of plausibility rules above are provided by way of example, but not limitation. The plausibility rules can be arbitrarily complex and new rules can be implemented as they are developed.

FIG. 7 is a diagrammatic representation providing an example of invertible and proto-invertible chiral atoms. In the example of FIG. 7, a compound structure can have four states represented at 702ᵢ, 702ⱼ, 702ₖ and 702ₗ. For each state, is the chirality, R or S, is also indicated. At states 702ᵢ and 702ₖ, nitrogen atom 704 is basic (i.e., can receive a hydrogen ion/undergo protonation) and has a lone pair of electrons 706. Transform (c) inverts the lone pair of electrons between states 702ᵢ and 702ₖ, which can cause the remaining atoms bonded to nitrogen atom 704 to shift. In this case, no bonds need to be broken. Inversion, such as shown by transform (c) can occur trillions of times a second in nature. Nitrogen atom 704 is “invertible.” Because nitrogen atom 704 has a pair of free electrons in states 702ᵢ and 702ₖ, a hydrogen atom 708 can bond to nitrogen atom 704. Transforms (a) and (b) of FIG. 7 are protonation transforms that add hydrogen ion 708 to transform state 702ᵢ to 702ⱼ and 702ₖ to 702ₗ, respectively. Because the nitrogen atom 708 has four other atoms attached in states 702ⱼ and 702ₖ, nitrogen atom 708 is no longer invertible. In other words, the compound can not shift from state 702ⱼ to 702ₗ (i.e., undergo transform (d)) without breaking bonds. Through protonation/deprotonation and inversion, however, the compound can shift from 702ⱼ to 702ₗ by losing a hydrogen (transform (a)), inverting (transform (c)) and gaining a hydrogen (transform (b)). Because 702ⱼ can invert to 702ₗ through protonation/deprotonation and inversion, nitrogen atom 704 at state 702ⱼ is “proto-invertible.”

For a protomer structure at 702ⱼ or 702ₗ, embodiments of the present invention can determine that nitrogen atom 704 is proto-invertible based on the fact that it has four non-equivalent atoms bonded to it in tetrahedral fashion and that it can undergo deprotonation. Identification of atoms that are proto-invertible can be based, for example, on a knowledge base of atoms and configurations for known proto-invertible chiral atoms. Thus, given the input structure for the compound at state 702ᵢ (an R state), embodiments of the present invention, by identifying nitrogen atom 708 as proto-invertible also identify the fact that there should be an S state for nitrogen atom 708. Similarly, for state 702ⱼ, if the protomer of state 702ᵢ is selected for further processing, embodiments of the present invention can identify that there should also be an S state based on the proto-invertible nitrogen atom 704.

FIG. 8 is a diagrammatic representation illustrating proto-invertible chiral atoms and proto-invertible chiral bonds. In the real world, structures 802ᵢ, 802ⱼ, 802ₖ and 802ₗ exist via tautomeric transforms. Structures 802ₘ and 802ₙ simply represent conformers of 802ᵢ and 802ₒ and 802ₚ represent conformers of 802ₖ. For the sake of example, at state 802ₘ, carbon atom 804 appears as a left handed (S) chiral atom. Carbon atom 804 can be identified as a proton-donor separated from proton-acceptor oxygen atom 806 by bond 810 and bond 812. Therefore, tautomeric transform (a) can occur to yield state 802ⱼ. In state 802ⱼ, oxygen atom 806 is again separated from carbon atom 804 by bond 810 and 812. Because X and Z are on opposite sides of double bond 810, it is an E bond. Hydrogen 814 can then move back to bond with carbon atom 804, either returning to state 802ᵢ or undergoing transform (b) to state 802ₒ. In state 802ₒ, carbon atom 804 has inverted to right handed chirality (R). Because bond 810 is now a single bond, rotation can occur to change from 802ₒ to 802ₚ. In this case, the structure remains the same. Tautomeric transform (c) can occur to bond hydrogen 814 with oxygen atom 806 to create Z bond 810 with atoms X and Z on the same side. If tautomeric transform (d) occurs, hydrogen 814 can return to carbon atom 804 to yield 802ₙ. Because bond 810 is now a single bond, 802ₙ can rotate back to 802ₘ without changing the structure of the compound.

In the example above, carbon atom 804 is a protomerically invertible atom and bond 810 is a protomerically invertible bond. Given, for example, a representation of the structure at 802ₘ, carbon atom 804 can be identified as a protomerically invertible atom and bond 810 can be identified as protomerically invertible bond. As with identification of protomerically invertible atoms, protomerically invertible bonds can be identified, for example, by comparing the structural information for a given protomer to a knowledge base of bond configuration that result in proto-invertible chiral bonds or through other mechanism of identifying proto-invertible bonds.

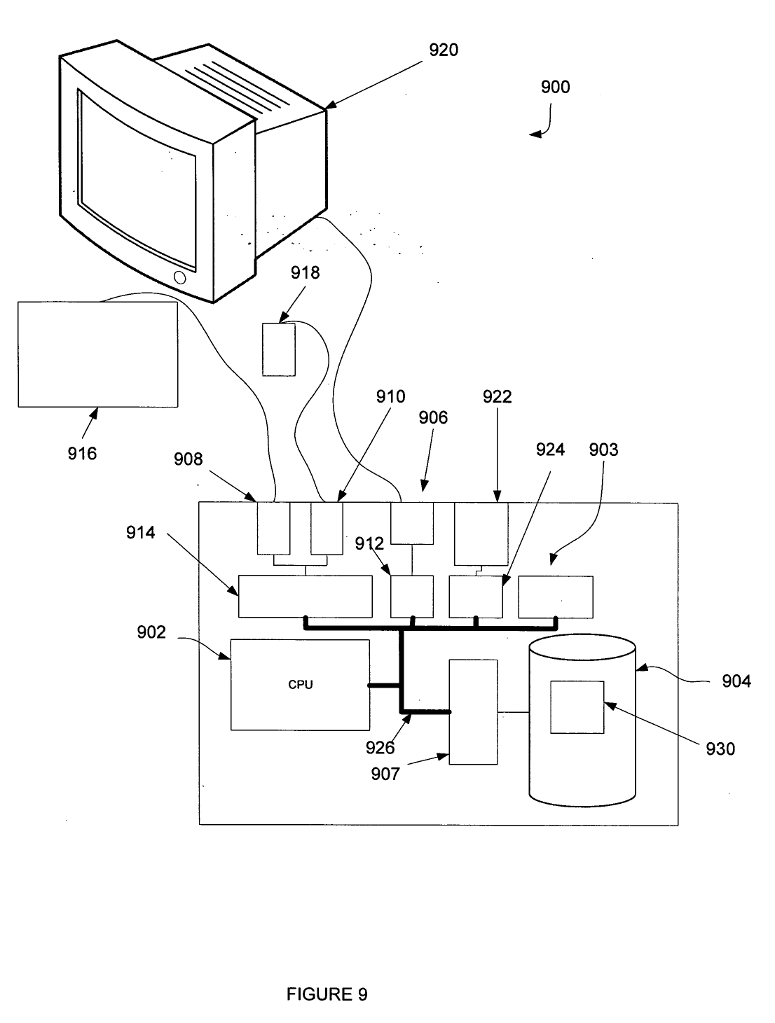

As described earlier, embodiments of the present invention can be implemented as a set of computer instructions stored on a computer readable medium (e.g., as a computer program product). FIG. 9 provides a diagrammatic representation of one embodiment of a computing device 900 that can provide a system for identifying structures of a compound. Computing device 900 can include a processor 902, such as an Intel Pentium 4 based processor (Intel and Pentium are trademarks of Intel Corporation of Santa Clara, Calif.), a primary memory 903 (e.g., RAM, ROM, Flash Memory, EEPROM or other computer readable medium known in the art) and a secondary memory 904 (e.g., a hard drive, disk drive, optical drive or other computer readable medium known in the art). A memory controller 907 can control access to secondary memory 904. Computing device 900 can include I/O interfaces, such as video interface 906 and universal serial bus (“USB”) interfaces 908 and 910 to connect to input and output devices. A video controller 912 can control interactions over the video interface 906 and a USB controller 914 can control interactions via USB interfaces 908 and 910. Computing device 900 can include a variety of input devices such as keyboard 916 and a mouse 918 and output devices such as display device 920 (e.g., a monitor). Computing device 900 can further include a network interface 922 (e.g., an Ethernet port or other network interface) and a network controller 924 to control the flow of data over network interface 922. Various components of computing device 900 can be connected by a bus 926.

Secondary memory 904 can store a variety of computer instructions that include, for example, an operating system such as a Windows operating system (Windows is a trademark of Redmond, Washington based Microsoft Corporation) and applications that run on the operating system, along with a variety of data. More particularly, secondary memory 904 can store a software program 930 that enumerate proto-stereomers for a given input structure. During execution by processor 902, portions of program 930 can be stored in secondary memory 904 and/or primary memory 903.

In operation, program 930 can be executable by processor 902 to read an input representation of a structure (e.g., a connection table) and extract structural information from the connection table (or other representation), canonically re-order the structural information, analyze the structural information to identify all proto-centers, modify the structural information to neutralize acidic/basic atoms, identify all proto-invertible centers from the structural information, remove any chiral specifications that are associated with proto-invertible centers found in the structural information, enumerate all possible neutral protomers by using tautomeric transforms, canonically rank the neutral protomers and identify a protomer as the canonically unique protomer for the compound. Program 930 can generate a canonically unique representation of the compound by, for example, generating a representation of the canonically unique protomer of the compound.

Computing device 900 of FIG. 9 is provided by way of example only and it should be understood that embodiments of the present invention can implemented as a set of computer instructions stored on a computer readable medium in a variety of computing devices including, but not limited to, desktop computers, laptops, mobile devices, workstations and other computing devices. Program 930 can be executable to receive and store data over a network and can include instructions that are stored at a number of different locations and are executed in a distributed manner. While shown as a stand alone program in FIG. 9, it should be noted that program 930 can be a module of a larger program, can comprise separate programs operable to communicate data to each other via, for example, UNIX pipes, or can be implemented according to any suitable programming scheme.

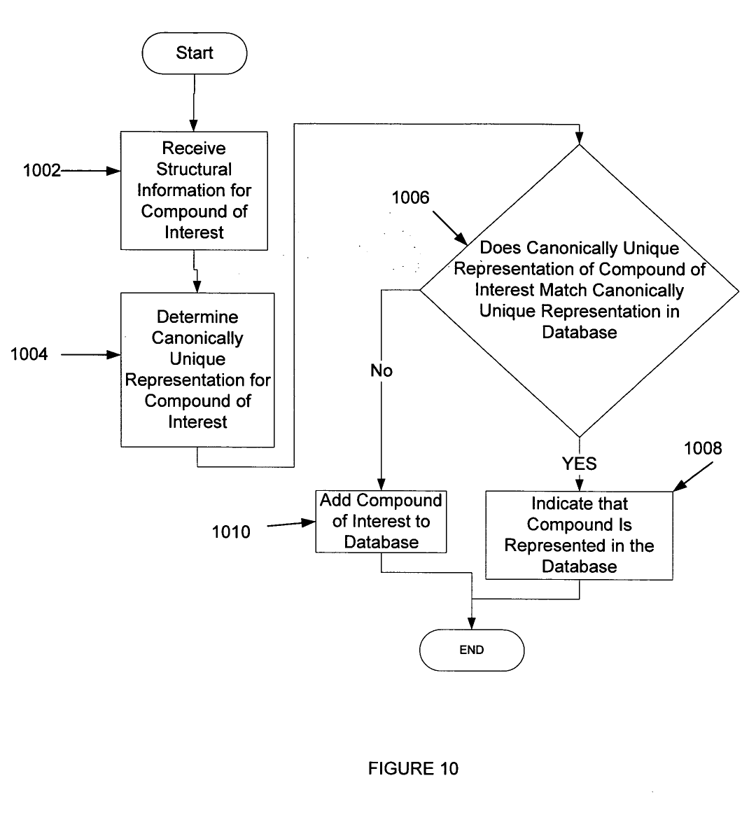

FIG. 10 is a flow chart illustrating one embodiment of determining whether a compound is already represented in a chemical database or other chemical inventory. At step 1002, a representation of a compound of interest can be received (e.g., in the form of a connection table or other representation). At step 1004, the canonically unique structural representation of the compound can be created as described in conjunction with FIG. 3. The canonically unique structural representation of the compound of interest can be the representation of a canonically unique protomer for that compound derived from normalized, neutralized structural data of the compound of interest. The canonically unique representation of the compound of interest can be compared to the set of canonically unique representations of compounds in the database to determine whether the canonically unique structural representation of the compound of interest matches any canonically unique structural representations in the chemical database (step 1006). If the canonically unique representation of the compound of interest matches a canonically unique representation from the set of canonically unique representations in the database, the compound of interest is already represented in the database. An indication that the compound of interest is already stored in the database can be returned to a human or programmatic user (step 1008). If, on the other hand, the canonically unique structural representation of the compound of interest does not match any of the canonically unique structural representations in the database, the compound of interest, at step 1010, can be added to the database (i.e., the canonically unique representation of the compound of interest can be added to the set of canonically unique representations to which it was compared). The methodology of FIG. 10 can be repeated as needed or desired.

Embodiments of the present invention provide advantages in chemical related research by providing a mechanism to canonically represent a compound based on any structure of the compound. This can allow, for example, researchers to determine if a particular chemical structure found in the literature, vendors' catalogs or existing databases corresponds to a compound already canonically represented in a database. This is useful for correlating lab results from experiments to the same compound, managing chemical inventories, and avoiding inadvertent purchase of duplicate compounds.

Although the present invention has been described in detail herein with reference to the illustrated embodiments, it should be understood that the description is by way of example only and is not to be construed in a limiting sense. It is to be further understood, therefore, that numerous changes in the details of the embodiment of this invention and additional embodiments of this invention will be apparent, and may be made by persons of ordinary skill in the art having reference to this description. It is contemplated that all such changes and additional embodiments are within the scope of the invention as claimed below.

1. A method for canonically representing a compound based on a representation of a structure of the compound that comprises structural information for the structure, comprising:
identifying proto-centers of the structure;
modifying the structural information to neutralize any acidic and basic atoms identified for the structure;
identifying any invertible and any proto-invertible centers for the structure;
removing stereochemical specifications for the identified invertible and proto-invertible centers;
identifying one or more neutral protomers from the structural information that has been normalized to neutralize acidic and basic atoms and to remove stereochemical specifications;
selecting, in a canonically specified fashion, one of the neutral protomers as the canonically unique protomer for the compound; and
creating a canonically unique representation of the compound based on the selected neutral protomer.

2. The method of claim 1, further comprising ordering the structural information in a canonical format.

3. The method of claim 2, wherein ordering the structural information according to a canonical format comprises ordering the structural information according to the Morgan algorithm.

4. The method of claim 2, wherein ordering of the structural information in a canonical format occurs before modifying the structural information to neutralize acidic/basic atoms.

5. The method of claim 4, wherein modifying the structural information to neutralize acidic and basic atoms occurs before removing stereochemical specifications from the structural information.

6. The method of claim 1, wherein identifying proto-centers comprises identifying acidic and basic atoms.

7. The method of claim 1, wherein identifying proto-centers comprises identifying true proton-donor and proton-acceptor pairs.

8. The method of claim 1, wherein selecting one of the neutral protomers as the canonically unique protomer for the compound further comprises:
ordering the neutral protomers; and
selecting the highest ranking neutral protomer as the canonically unique protomer for the compound.

9. A computer program comprising a set of computer instructions stored on a computer readable medium, the set of computer instructions comprising instructions executable to:
receive a representation of a structure of a compound, wherein the structural representation comprises structural information for the structure;
identify proto-centers of the structure;
modify the structural information to neutralize any acidic and basic atoms identified for the structure;
identify any invertible and proto-invertible centers for the structure;
remove stereochemical specifications for the identified invertible and proto-invertible centers;
identify one or more neutral protomers from the structural information that has been normalized to neutralize any acidic and basic atoms and to removing stereochemical specifications;
select one of the neutral protomers as the canonically unique protomer for the compound; and
create a canonically unique representation and identifier of the compound based on the selected neutral protomer.

10. The computer program product of claim 9, wherein the set of computer instructions further comprise instructions executable to order the structural information in a canonical format.

11. The computer program product of claim 10, wherein ordering the structural information according to a canonical format comprises ordering the structural information according to the Morgan algorithm.

12. The computer program product of 10, wherein ordering of the structural information in a canonical format occurs before modifying the structural information to neutralize acidic and basic atoms.

13. The computer program product of claim 12, wherein modifying the structural information to neutralize acidic and basic atoms occurs before removing stereochemical specifications from the structural information.

14. The method of claim 9, wherein identifying proto-centers comprises identifying acidic and basic atoms.

15. The method of claim 9, wherein identifying proto-centers comprises identifying true proton-donor and proton-acceptor pairs.

16. The computer program product of 9, wherein the instructions for selecting one of the neutral protomers as the canonically unique protomer for the compound further comprises further comprise instructions executable to:
order the neutral protomers; and
select the highest ranking neutral protomer as the canonically unique protomer for the compound.

17. A method for representing a compound based on a representation of a structure of the compound that comprises structural information for the structure, comprising:
receiving a representation of a structure of a compound, wherein the structural representation comprises structural information for the structure;
canonically ordering the structural information;
identifying acidic and basic atoms for the structure;
identifying true proton-donor/proton-acceptors pairs for the structure;
modifying the structural information to neutralize any acidic and basic atoms identified for the structure;
identifying any invertible and any proto-invertible centers for the structure;
removing stereochemical specifications for the identified invertible and proto-invertible centers;
identifying one or more neutral protomers from the structural information that has been normalized to neutralize acidic and basic atoms and to remove stereochemical specifications;
canonically ranking the neutral protomers and selecting one of the neutral protomers as the canonically unique protomer for the compound; and
creating a canonically unique representation of the compound based on the canonically selected neutral protomer.

18. The method of claim 17, wherein canonically ordering the structural information comprises ordering the structural information according to the Morgan algorithm.

19. The method of claim 18, wherein ordering of the structural, information in a canonical format occurs before modifying the structural information to neutralize acidic and basic atoms.

20. The method of claim 19, wherein modifying the structural information to neutralize acidic and basic atoms occurs before removing stereochemical specifications from the structural information.

21. The method of claim 17, wherein identifying one or more neutral protomers comprises performing in silico tautomeric transforms using the true proton-donor/proton-acceptor pairs according to a set of plausibility rules.

22. The method of claim 17, wherein identifying one or more neutral protomers comprises performing in silico tautomeric transforms using the true proton-donor/proton-acceptor pairs subject to calculated molecular energies.

23. The method of claim 17, wherein selecting a neutral protomer as the canonically unique protomer further comprises selecting the highest ranking neutral protomer as the canonically unique protomer for the compound.

24. A method for determining if a compound is represented in a database comprising:
receiving a representation of a structure of a compound of interest, wherein the representation of the structure of the compound of interest comprises structural information for the compound of interest;
generating a canonically unique representation of the compound of interest; and
comparing the canonically unique representation of the compound of interest to a set of canonically unique representations of compounds in the database to determine if the canonically unique representation of the compound of interest matches a canonically unique representation in the set of canonically unique representations of compounds in the database.

25. The method of claim 24, wherein generating the canonically unique representation of the compound of interest further comprises:
identifying proto-centers of the structure;
modifying the structural information to neutralize acidic and basic atoms;
identifying invertible and proto-invertible centers for the structure;
removing stereochemical specifications for the identified proto-invertible centers;
identifying one or more neutral protomers from the structural information that has been normalized to neutralize acidic and basic atoms and to remove stereochemical specifications;
selecting one of the neutral protomers as the canonically unique protomer for the compound of interest; and
generating the canonically unique representation of the compound based on the selected neutral protomer.

26. The method of claim 24, further comprising adding the canonically unique representation of the compound of interest to the set of canonically unique representations of compounds in the database if the canonically unique representation of the compound of interest does not match any canonically unique representation in the set of canonically unique representations of compounds in the database.

27. A computer program product comprising a set of computer instructions stored on a computer readable medium, the set of computer instructions comprising instructions executable to:
receive a representation of a structure of a compound, wherein the structural representation comprises structural information for the structure;
canonically order the structural information;
identify acidic and basic atoms for the structure;
identify true proton-donor/proton-acceptors pairs for the structure;
modify the structural information to neutralize any acidic and basic atoms identified for the structure, creating neutralized structural information;
identify invertible and proto-invertible centers for the structure;
remove stereochemical specifications for the identified invertible and proto-invertible centers;
identify one or more neutral protomers from the structural information that has been normalized to neutralize acidic and basic atoms and to remove stereochemical specifications,;
canonically rank the neutral protomers and selecting one of the neutral protomers as the canonically unique protomer for the compound; and
create a canonically unique representation and identifier of the compound based on the selected neutral protomer.

28. The computer program product of claim 27, wherein canonically ordering the structural information comprises ordering the structural information according to the Morgan algorithm.

29. The computer program product of claim 28, wherein ordering of the structural information in a canonical format occurs before modifying the structural information to neutralize acidic/basic atoms.

30. The computer program product of claim 29, wherein modifying the structural information to neutralize acidic/basic atoms occurs before removing stereochemical specifications from the structural information.

31. The computer program product of claim 27, wherein identifying one or more neutral protomers comprises performing in silico tautomeric transforms using the true proton-donor/proton-acceptor pairs according to a set of plausibility rules.

32. The computer program product of claim 27, wherein identifying one or more neutral protomers comprises performing in silico tautomeric transforms using the true proton-donor/proton-acceptor pairs subject to calculated molecular energies.

33. The computer program product of claim 27, wherein selecting a neutral protomer as the canonically unique protomer further comprises selecting the highest ranking neutral protomer as the canonically unique protomer for the compound.

34. A computer program product for determining if a compound is represented in a database comprising a set of computer instructions stored on a computer readable medium, the set of computer instructions comprising instructions executable to:
receive a representation of a structure of a compound of interest, wherein the representation of the structure of the compound of interest comprises structural information for the compound of interest;
generate a canonically unique representation of the compound of interest; and
compare the canonically unique representation of the compound of interest to a set of canonically unique representations of compounds in the database to determine if the canonically unique representation of the compound of interest matches any of the canonically unique representation in the set of canonically unique representations of compounds in the database.

35. The computer program product of claim 34, wherein the instructions executable to generate a canonically unique representation further comprise instructions executable to:
identify proto-centers of the structure;
modify the structural information to neutralize acidic/basic atoms;
identify invertible and proto-invertible centers for the structure;
remove stereochemical specifications for the identified invertible and proto-invertible centers;
identify one or more neutral protomers from the structural information that has been normalized to neutralize the acidic and basic atoms and to remove stereochemical specifications from invertible and proto-invertible atoms and bonds based on the true proton-donor/proton acceptor pairs identified;
select one of the neutral protomers as the canonically unique protomer for the compound of interest; and
generate the canonically unique representation and identifier of the compound based on the selected neutral protomer.

36. The computer program product of claim 34, wherein if the canonically unique representation of the compound of interest does not match any of the canonically unique representation in the set of canonically unique representations of compounds in the database, adding the canonically unique representation of the compound of interest to the set of canonically unique representations of compounds in the database.
